(19) United States
(12) Patent Application Publication
(10) Pub. No.: US 2022/0038813 A1
(43) Pub. Date: Feb. 3, 2022

(54) HEADPHONES

(71) Applicant: Yamaha Corporation, Hamamatsu (JP)

(72) Inventor: Tomoaki MORI, Hamamatsu (JP)

(21) Appl. No.: 17/389,228

(22) Filed: Jul. 29, 2021

(30) Foreign Application Priority Data
Jul. 31, 2020 (JP) 2020-129921

(51) Int. Cl. H04R 1/28

(52) U.S. Cl. CPC H04R 1/2873; H04R 1/1016; H04R 2460/01; H04R 1/288

(57) ABSTRACT

Headphones include at least one headphone unit each having a speaker unit, a chamber that covers a back surface of the speaker unit, a housing that is disposed on a side of the back surface of the speaker unit, in which the chamber is disposed, and that covers the chamber, and a vibration damper that connects the chamber and the speaker unit.

### CROSS-REFERENCE TO RELATED APPLICATIONS

This application claims priority to Japanese Patent Application No. 2020-129921, filed on Jul. 31, 2020. The entire disclosure of Japanese Patent Application No. 2020-129921 is hereby incorporated herein by reference.

### BACKGROUND

### Technical Field

One embodiment of this disclosure relates to headphones.

### Background Information

Headphones generally include speaker units, housings, and baffle plates which serve as support substrates for the speaker units. Ear pads that cover the user's ears are attached on the sides of the baffle plates that contact the user's ears. In addition, the speaker units are attached on the sides of the baffle plates opposite to the sides on which the ear pads are attached (for example, refer to Japanese Laid-Open Patent Publication No. 2003-179990). In addition, there are headphones that have sound-absorbing material (for example, refer to Japanese Laid-Open Patent Publication No. 2019-334656).

### SUMMARY

However, conventional headphones do not give consideration to suppressing unwanted resonance generated in the housing.

An object of one embodiment of this disclosure is to suppress unwanted resonance of the housing.

The headphones according to one embodiment of this disclosure comprise at least one headphone unit each having a speaker unit, a chamber that covers a back surface of the speaker unit, a housing that is disposed on a side of the back surface of the speaker unit, in which the chamber is disposed, and that covers the chamber, and a vibration damper that connects the chamber and the speaker unit.

The headphones according to one embodiment of this disclosure are able to suppress unwanted resonance of the housings.

### BRIEF DESCRIPTIONS OF THE DRAWINGS

FIG. 1A is a cross-sectional view of a left-side headphone unit of headphone units.

FIG. 1B is a cross-sectional view of a right-side headphone unit of the headphone units.

FIG. 2 is an exploded perspective view showing a part of the left-side headphone unit.

FIG. 3A is an explanatory diagram showing a reference example of frequency characteristics of headphones not provided with a vibration damper.

FIG. 3B is an explanatory diagram showing one example of frequency characteristics of headphones provided with a vibration damper.

FIG. 4A is an explanatory diagram showing a reference example of phase characteristics of the headphones not provided with the vibration damper.

FIG. 4B is an explanatory diagram showing one example of phase characteristics of the headphones provided with the vibration damper.

FIG. 5A is a cross-sectional view of a left-side headphone unit of headphone units of a first modification.

FIG. 5B is a cross-sectional view of a right-side headphone unit of the headphone units of the first modification.

FIG. 6 is a cross-sectional view of a left-side headphone unit of a second modification.

FIG. 7 is a cross-sectional view of a left-side headphone unit of a third Modification.

### DETAILED DESCRIPTION OF THE EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

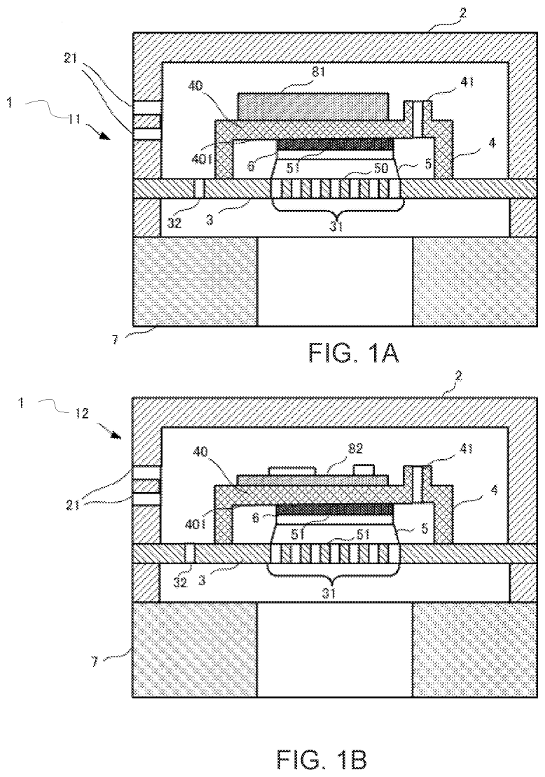

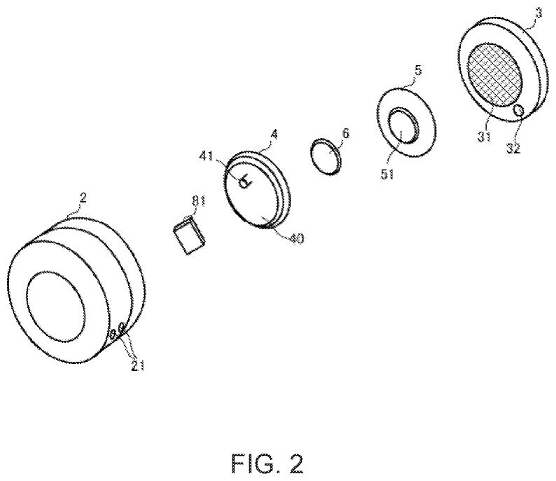

Headphones 1 according to the present embodiment will be described with reference to the drawings. Headphones 1 comprise a left-side headphone unit (first headphone unit) 11 and a right-side headphone unit (second headphone unit) 12. The left-side headphone unit 11 and the right-side headphone unit 12 are connected by a headband (not shown). The outer appearance of the headphones 1 is the same as generic headphones, and thus an illustration is omitted. FIG. 1A is a cross-sectional view of the left-side headphone unit 11. FIG. 1B is a cross-sectional view of the right-side headphone unit 12. FIG. 2 is an exploded perspective view of the left-side headphone unit 11.

The headphones 1 according to the present embodiment are connected to an audio device, such as a music player, an audio mixer, or a smartphone, wirelessly or by wire. The headphones 1 receive sound signals from the audio device, convert the received sound signals into sound, and emit the sound.

The headphones 1 have an active noise cancelling (ANC) function. The headphones 1 according to the present embodiment are configured to increase the sound pressure of the low range by bass reflex ports that utilize Helmholtz resonance. However, in this disclosure, having the ANC function and the bass reflex ports is not essential.

As shown in FIGS. 1A, 1B, and 2, each of the left-side headphone unit 11 and the right-side headphone unit 12 comprises a housing 2, a baffle plate 3, a chamber 4, a speaker unit (speaker) 5, a vibration damper (vibration damping material) 6, and an ear pad 7.

In addition, the left-side headphone unit 11 includes a battery 81. The right-side headphone unit 12 includes an electronic board 82. The left-side headphone unit 11, although not shown, also includes an electronic board 82.

The left-side headphone unit 11 will be described in detail. The right-side headphone unit 12 is different only in the presence/absence of the battery 81, and the other configurations are the same. Therefore, only the left-side headphone unit 11 will be described here as a representative example.

As shown in FIGS. 1A, 1B, and 2, the housing 2 is in the form of a hollow cylinder with an open first end that faces the baffle plate 3. The speaker unit 5, the chamber 4, and the vibration damper 6 are disposed inside the housing 2. Through-holes 21 are provided on the side wall of the housing 2. The through-holes 21 are provided mainly to conduct air. The housing 2 blocks external disturbance noise. The chamber 4 disposed inside the housing 2 is thereby capable of preventing resonance caused by external disturbances.

The baffle plate 3 is disk-shaped. The baffle plate 3 is connected to the housing 2 and covers the open end of the housing 2. In other words, the peripheral edge of the baffle plate 3 is connected to the open end of the housing 2. The baffle plate 3 is provided with a grill 31 formed with a plurality of openings for allowing the sound from the speaker unit 5 to pass through at the center portion facing a sound emitting part 50 of the speaker unit 5. In addition, the baffle plate 3 is provided with a first port 32 for bass reflex, which penetrates in the thickness direction.

The speaker unit 5 is disposed on the center portion (grill 31) of the baffle plate 3. The speaker unit 5 has an active noise cancelling (ANC) function.

The chamber 4 is provided in a space formed by the housing 2 and the baffle plate 3. The chamber 4 is in the form of a hollow cylinder with an open first end on the baffle plate 3 side, The open end of the chamber 4 is connected to the baffle plate 3. That is, the baffle plate 3 is disposed to cover the open end of the chamber 4. The chamber 4 contains the speaker unit 5. The chamber 4 is disposed to cover the outer circumferential surface and back surface (rear surface) 51 of the speaker unit 5. More specifically, the chamber 4 is disposed such that an inner surface 401 of a bottom wall 40 and the back surface 51 of the speaker unit 5 face each other. The chamber 4 functions as a cavity of a Helmholtz resonator. In addition, the chamber 4 also has the function of insulating the sound of the speaker unit 5.

The chamber 4 is provided with a second port 41 for bass reflex formed on the bottom wall 40. The second port 41 is in the form of a cylinder with two open ends, and projects toward the outer side of the bottom wall 40. In this case, the speaker unit 5 is disposed inside the chamber 4 so as not to block the opening of the second port 41.

The vibration damper 6 is disk-shaped. In this example, the surface area of the vibration damper 6 is the same as the surface area of the back surface 51 of the speaker unit 5. The vibration damper 6 is disposed between the back surface 51 of the speaker unit 5 and the inner surface 401 of the bottom wall 40 of the chamber 4. A first surface of the vibration damper 6 is connected to the back surface 51 of the speaker unit 5. In addition, a second surface of the vibration damper 6 is connected to the inner surface 401 of the bottom wall 40 of the chamber 4. The vibration damper 6 is formed from a material such as urethane.

The battery 81 is disposed on the outer surface of the bottom wall 40 of the chamber 4. That is, the battery 81 is provided on the opposite side of the vibration damper 6 with respect to the bottom wall 40 of the chamber 4. The electronic board 82 is provided on the outer surface of the bottom wall 40 of the chamber 4, in the same manner as the battery 81.

The ear pad 7 is provided on the side of the baffle plate 3 opposite to the side on which the speaker unit 5 is disposed. The ear pad 7 is cylindrical in shape. The central portion of the ear pad 7 is open so that the sound emitted from the sound emitting part 50 of the speaker unit 5 reaches the outside (i.e., the ear of the user).

In general, the housings of the headphones are formed so as to be thin, in anticipation of portability. Therefore, when the volume of the housing is decreased, the housing tends to resonate due to the sound of the speaker unit. As a result, the frequency characteristics and the phase characteristics (phase at the frequency) of the sound signal are disturbed. As a result, the sound quality of the headphones decreases.

In addition, if the battery is provided only in the left-side headphone unit or the right-side headphone unit, the headphone unit in which the battery is provided can suppress resonance by the battery, which is relatively heavy. However, without the battery, the resonance of the headphone unit becomes large. As a result, the magnitude of the resonance of the housing differs between the left-side headphone unit and the right-side headphone unit. Therefore, the frequency characteristics and the phase characteristics of the left-side headphone unit and the right-side headphone unit will differ.

For example, if the frequency characteristics or the phase characteristics of the left-side headphone unit and the right-side headphone unit differ, the volume, localization, sound quality, etc., differ as a function of frequency, so that the user may experience discomfort. In addition, since the ANC function utilizes phase interference, if the frequency characteristics and the phase characteristics are different on the left and the right sides in the low- to mid-frequency range (for example, less than or equal to 300 Hz), the noise-cancellation effect is reduced.

In contrast, in the headphones 1 of the present embodiment, the chamber 4 is disposed in the housing 2, and thereby prevents resonance of the housing 2 due to the sound of the speaker unit 5. The chamber 4 also prevents resonance caused by external disturbance noise.

In addition, in the headphones 1 of the present embodiment, the vibration damper 6 is sandwiched between the speaker unit 5 and the chamber 4 and thereby suppresses resonance of the chamber 4. In the headphones 1 of the present embodiment, the battery 81 is provided only in the left-side headphone unit 11, but the resonance of the left-side headphone unit 11 and that of the right-side headphone unit 12 are suppressed to the same level.

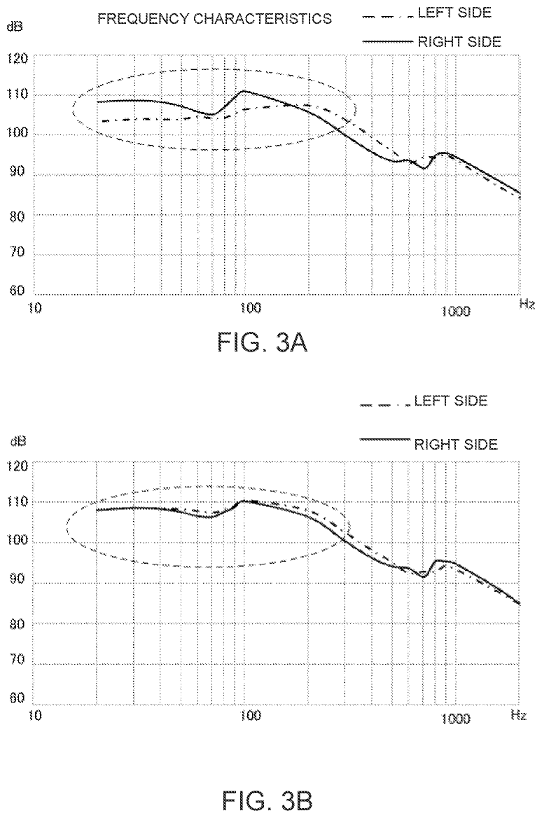

FIG. 3A is an explanatory diagram showing one example of the frequency characteristics of the left-side headphone unit 11 and the right-side headphone unit 12 in which the vibration damper 6 is not provided, as a reference example. Aside from the presence/absence of the vibration damper 6, the reference headphones have the same configuration as the headphones 1 of the present embodiment. FIG. 3B is an explanatory diagram showing one example of the frequency characteristics of the left-side headphone unit 11 and the right-side headphone unit 12 in which the vibration damper 6 is provided.

As shown in FIG. 3A, the frequency characteristics of the left-side headphone unit and the right-side headphone unit in which the vibration damper 6 is not provided display characteristics that are different particularly in the low- to mid-frequency range.

On the other hand, in the present embodiment, the vibration damper 6 is provided between the speaker unit 5 and the chamber 4. Thus, as shown in FIG. 3B, the frequency characteristics of the left-side headphone unit 11 and the right-side headphone unit 12 display similar characteristics particularly in the low- to mid-frequency range. As a result, the user can hear sounds from the left-side headphone unit 11 and the right-side headphone unit 12 without discomfort. In addition, the difference between the noise cancellation effect on left and right sides can also be reduced.

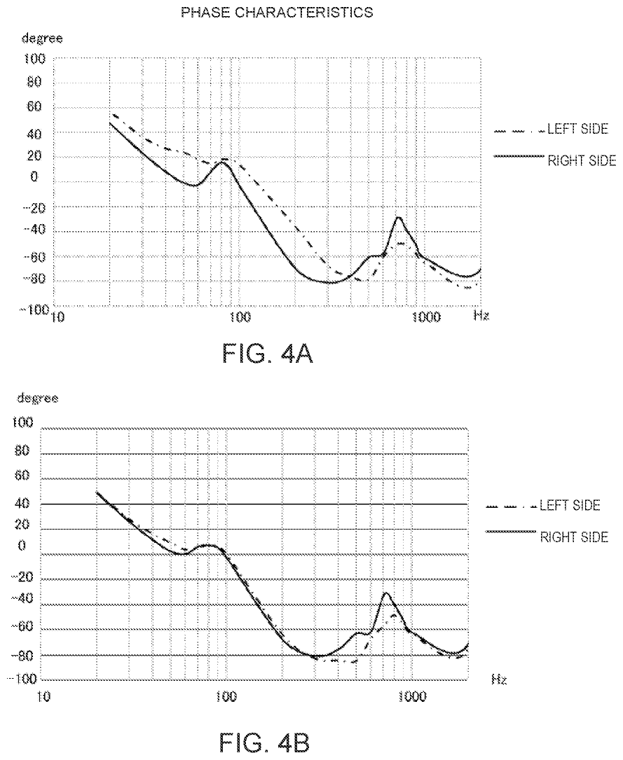

FIG. 4A is an explanatory diagram showing one example of the phase characteristics of the left-side headphone unit 11 and the right-side headphone unit 12 of the reference example in which the vibration damper 6 is not provided. FIG. 4B is an explanatory diagram showing one example of the phase characteristics of the left-side headphone unit 11 and the right-side headphone unit 12 in which the vibration damper 6 is provided.

As shown in FIG. 4A, with respect to the headphones of the reference example, in the low-frequency range up to 400 Hz, the right-side headphone unit lags the left-side headphone unit in phase. For example, in the vicinity of 50 Hz, there is a phase difference between the left-side headphone unit and the right-side headphone unit of about 20°. In addition, in the vicinity of 200 Hz, there is a phase difference between the left-side headphone unit and the right-side headphone unit of about 40°. In this manner, in headphones in which the vibration damper 6 is not provided, the phase difference between the left-side headphone unit and the right-side headphone unit is large.

On the other hand, as shown in FIG. 4B, according to the present embodiment, in the low range up to 300 Hz, there is hardly any phase difference between the left-side headphone unit 11 and the right-side headphone unit 12. In this manner, it is possible to suppress unwanted resonance of the chamber 4 by damping the chamber 4 by the vibration damper 6. In addition, when the resonance of the chamber 4 is suppressed, the resonance of the housing 2 is also suppressed.

As a result of the suppression of the resonance of the chamber 4 and the housing 2, the phase and frequency characteristics of the left-side headphone unit 11 and the right-side headphone unit 12 have similar values in the low range of 300 Hz or less. As a result, the difference in sound quality between the left and right disappears. In addition, the phase delay in frequencies of about 300 Hz is also improved by about 10°. Thus, the effect of the ANC function improves. In addition, the vibration damper 6 blocks the external disturbance noise from entering from the outside by the chamber 4. The sound insulation property of the left-side headphone unit 11 and the right-side headphone unit 12 is thereby improved.

In this mariner, because the headphones 1 are provided with the vibration damper 6, it is possible to suppress unwanted resonance of the chamber 4 and the housing 2, and to improve the sound quality.

The material constituting the vibration damper 6 is not limited to urethane. The vibration damper 6 can be formed of another elastic material, such as silicone rubber.

The second port 41 of the chamber 4 is not limited to the example of the embodiment. It is sufficient as long as the second port 41 is provided on either the bottom wall 40 or the side wall of the chamber 4.

In addition, the headphones also include so-called inner-ear type earphones. Even for inner-ear type earphones, the same effect can be exhibited by providing the chamber in the housing and disposing vibration damper between the chamber and the driver.

### First Modification

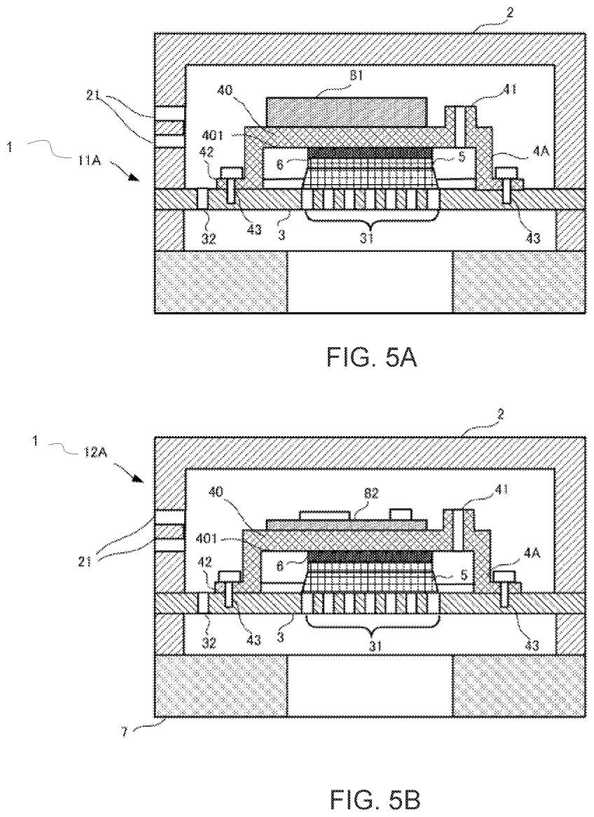

The headphones 1 according to a first modification will be described with reference to FIGS. 5A and 5B. FIGS. 5A and 5B are cross-sectional views of a left-side headphone unit 11A and a right-side headphone unit 12A of the first modification. Components that are the same as those of the embodiment described above have been assigned the same reference symbols, and their descriptions have been omitted.

The headphones 1 of the first modification comprise the left-side headphone unit 11A and the right-side headphone unit 12A. In each of the left-side headphone unit 11A and the right-side headphone unit 12A, a chamber 4A is fixed to the baffle plate 3 by screws 43.

More specifically, a fringe 42 that projects toward the outside is provided at the peripheral edge of the open end of the chamber 4A. For example, a plurality of screw holes (through-holes) are provided in the fringe 42. In addition, screw holes are also provided on the baffle plate 3, in places corresponding to the plurality of screw holes provided in the fringe 42. In this manner, screws 43 are screwed through the screw holes of the fringe 42 and into the screw holes of the baffle plate 3. As a result, the chamber 4 is reliably fixed to the baffle plate 3. When the fringe 42 is fixed to the baffle plate 3, the chamber 4 is fixed to the baffle plate 3 such that pressure is applied to the first surface and the second surface of the vibration damper 6. That is, the vibration damper 6 is disposed between the baffle plate 3 and the chamber 4 in a compressed state. As a result, the left-side headphone unit 11A and the right-side headphone unit 12A are further damped, and resonance of the housing 2 can be suppressed.

### Second Modification

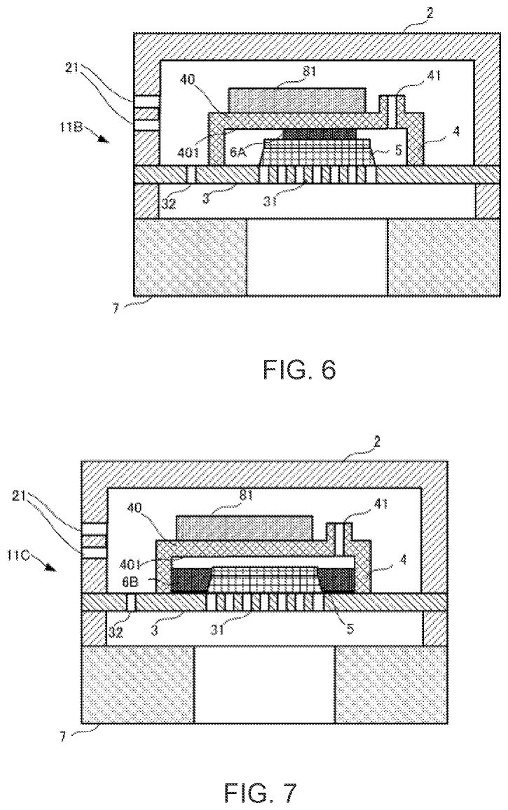

The headphones 1 according to a second modification will be described with reference to FIG. 6. FIG. 6 is a cross-sectional view of a left-side headphone unit 11B according to the second modification. Components that are the same as those of the embodiment described above have been assigned the same reference symbols, and their descriptions have been omitted.

The surface area of a vibration damper 6A is not limited to the same area as the back surface 51 of the speaker unit 5. As shown in FIG. 6, the vibration damper 6A is in the form of a disk that is smaller than the surface area of the back surface 51 of the speaker unit 5.

In addition, the shape of the vibration damper 6A is not limited to that of a disk or a cylinder. The vibration damper 6A needs only be connected to part of the chamber 4 and part of the speaker unit 5. The vibration damper 6A can be rectangular plate-shaped or elliptical plate-shaped, for example.

In this manner, when the vibration damper 6A is sandwiched between part of the chamber 4 and part of the speaker unit 5, the left-side headphone unit 11B is damped, and it is possible to suppress resonance of the housing 2. If the same vibration damper 6A is provided in the right-side headphone unit, the right-side headphone unit is damped in the same mariner as the left-side headphone unit 11B, and it is possible to suppress resonance of the housing 2.

### Third Modification

The headphones 1 according to a third modification will be described with reference to FIG. 7. FIG. 7 is a cross-sectional view of a left-side headphone unit 11C according to the third modification. Components that are the same as those of the embodiment described above have been assigned the same reference symbols, and their descriptions have been omitted.

As shown in FIG. 7, a vibration damper 6B can be disposed between a side surface of the speaker unit 5 and the inner surface of a side wall of the chamber 4, for example. In this case, the vibration damper 6B can be in the form of an open-ended cylinder. In addition, the vibration damper 6B can be disposed so as to be sandwiched between part of the side surface of the speaker unit 5 and part of the side wall of the chamber 4.

In this manner, it is not necessary for the vibration damper to be disposed between the back surface 51 of the speaker unit 5 and the inner surface 401 of the bottom wall 40 of the chamber 4. As long as the vibration damper 6B is sandwiched between all or part of the side surface of the chamber 4 and the side surface or a part of the speaker unit 5, the left-side headphone unit 11C is damped, and it is possible to suppress resonance of the housing 2. If the same vibration damper 6B is provided in the right-side headphone unit, the right-side headphone unit is damped in the same manner as the left-side headphone unit 11C, and it is possible to suppress resonance of the housing 2.

The description of the present embodiment is in all respects only in the form of an example and should not be considered restrictive. The scope of this disclosure is indicated by the Claims section, not by the above-described embodiment. Furthermore, the scope of this disclosure is intended to include a scope that is equivalent to that of the Claims, as well as all modifications that are within the scope.

What is claimed is:

1. Headphones comprising:
at least one headphone unit each having
a speaker unit,
a chamber that covers a back surface of the speaker unit,
a housing that is disposed on a side of the back surface of the speaker unit, in which the chamber is disposed, and that covers the chamber, and
a vibration damper that connects the chamber and the speaker unit.

2. The headphones according to claim 1, wherein
the vibration damper is disposed between the back surface of the speaker unit and a surface of the chamber that faces toward the back surface of the speaker unit.

3. The headphones according to claim 1, wherein
the speaker unit has an active noise cancelling function.

4. The headphones according to claim 1, wherein
the at least one headphone unit includes a first headphone unit and a second headphone unit,
each of the first headphone unit and the second headphone unit has the speaker unit, the chamber, the housing, and the vibration damper, and
the first headphone unit further has a battery that is disposed inside the first headphone unit.

5. The headphones according to claim 4, wherein
the battery is connected to the chamber.

6. The headphones according to claim 1, wherein
each of the at least one headphone unit further has a baffle plate, the chamber is fixed to the baffle plate, and
the vibration damper is held between the chamber and the speaker unit.

7. The headphones according to claim 1, wherein
the chamber functions as a Helmholtz resonator.

8. The headphones according to claim 2, wherein
the speaker unit has an active noise cancelling function.

9. The headphones according to claim 2, wherein
the at least one headphone unit includes a first headphone unit and a second headphone unit,
each of the first headphone unit and the second headphone unit has the speaker unit, the chamber, the housing, and the vibration damper, and
the first headphone unit further has a battery that is disposed inside the first headphone unit.

10. The headphones according to claim 3, wherein
the at least one headphone unit includes a first headphone unit and a second headphone unit,
each of the first headphone unit and the second headphone unit has the speaker unit, the chamber, the housing, and the vibration damper, and
the first headphone unit further has a battery that is disposed inside the first headphone unit.

11. The headphones according to claim 8, wherein
the at least one headphone unit includes a first headphone unit and a second headphone unit,
each of the first headphone unit and the second headphone unit has the speaker unit, the chamber, the housing, and the vibration damper, and
the first headphone unit further has a battery that is disposed inside the first headphone unit.

12. The headphones according to claim 2, wherein
each of the at least one headphone unit further has a baffle plate, the chamber is fixed to the baffle plate, and
the vibration damper is held between the chamber and the speaker unit.

13. The headphones according to claim 3, wherein
each of the at least one headphone unit further has a baffle plate, the chamber is fixed to the baffle plate, and
the vibration damper is held between the chamber and the speaker unit.

14. The headphones according to claim 4, wherein
each of the first headphone unit and the second headphone further has a baffle plate, the chamber is fixed to the baffle plate, and
the vibration damper is held between the chamber and the speaker unit.

15. The headphones according to claim 5, wherein
each of the first headphone unit and the second headphone further has a baffle plate, the chamber is fixed to the baffle plate, and
the vibration damper is held between the chamber and the speaker unit.

16. The headphones according to claim 8, wherein
each of the at least one headphone unit further has a baffle plate, the chamber is fixed to the baffle plate, and
the vibration damper is held between the chamber and the speaker unit.

17. The headphones according to claim 11, wherein
each of the first headphone unit and the second headphone further has a baffle plate, the chamber is fixed to the baffle plate, and
the vibration damper is held between the chamber and the speaker unit.
